(19) United States
(12) Patent Application Publication
(10) Pub. No.: US 2008/0089539 A1
(43) Pub. Date: Apr. 17, 2008

(54) WIRELESS HEADPHONES

(76) Inventor: Kentaroh Ishii, Katsuragi-shi (JP)

Correspondence Address: BIRCH STEWART KOLASCH & BIRCH, PO BOX 747, FALLS CHURCH, VA, 22040-0747, US

(21) Appl. No.: 11/867,056

(22) Filed: Oct. 4, 2007

(30) Foreign Application Priority Data
Oct. 17, 2006 (JP) 2006-282626

(51) Int. Cl. H04R 5/02

(52) U.S. Cl. 381/311; 381/74

(57) ABSTRACT

The wireless headphone 10 that receives an audio signal P in the form of an optical signal including a right-channel sound signal and a left-channel sound signal and that outputs sound from an audio output portion 12 is provided with first and second light receiving portions 15 and 16 that are disposed so as to be directed in different directions and receive the audio signal P. The wireless headphone 10 compares the S/N ratios of the signals received by the first and second light receiving portions 15 and 16, and, based on the comparison result, switches an output from the audio output portion 12 between right-channel sound and left-channel sound.

This nonprovisional application claims priority under 35 U.S.C. § 119(a) on Patent Application No. 2006-282626 filed in Japan on Oct. 17, 2006, the entire contents of which are hereby incorporated by reference.

### BACKGROUND OF THE INVENTION

1. Field of the Invention

The present invention relates to wireless headphones that receive an audio signal in the form of an optical signal and output sound.

2. Description of Related Art

Conventional wireless headphones are disclosed in JP-U-H07-011092. These wireless headphones are provided with a pair of housings each having a light receiving element therein for receiving infrared radiation, and receive an audio signal in the form of an optical signal transmitted from a music player or the like. The received audio signal is separated into right-channel sound and left-channel sound. The right-channel sound is outputted from a loudspeaker provided in one of these headphones; the left-channel sound is outputted from a loudspeaker provided in the other. This makes it possible to eliminate the inconvenience the connecting cord of the headphones may cause.

JP-A-2005-286919 discloses a pair of wireless headphones each having a switch button for switching an output between right-channel sound and left-channel sound. This eliminates the need to make a distinction between right and left wireless headphones when they are placed over the ears, making it possible to enhance the convenience of the wireless headphones.

However, the wireless headphones disclosed in JP-A-2005-286919 require the switch buttons to be operated after the wireless headphones are placed over the ears. In addition, there is a possibility that the right and left headphones may be accidentally switched to a left-channel sound output and to a right-channel sound output, respectively. This undesirably impairs a sense of realism the music in stereo, for example, originally has.

### SUMMARY OF THE INVENTION

It is an object of the present invention to provide wireless headphones that can enhance the convenience thereof without the need for any user operation. Another object of the present invention is to provide wireless headphones that can properly deliver right-channel sound and left-channel sound to the right ear and to the left ear, respectively.

To achieve the above object, according to one aspect of the present invention, in a wireless headphone that receives an audio signal including a right-channel sound signal and a left-channel sound signal and outputs sound from an audio output portion, the audio signal is in the form of an optical signal, and there is provided first and second light receiving portions disposed so as to be directed in different directions, the first and second light receiving portions receiving the audio signal. Here, the S/N ratios or signal levels of the signals received by the first and second light receiving portions are compared so that, based on the comparison result, an output from the audio output portion is switched between right-channel sound and left-channel sound.

With this structure, an audio signal into which a right-channel sound signal and a left-channel sound signal are multiplexed is transmitted in the form of an optical signal, such as infrared radiation, from a music player or the like. When the wireless headphone is placed over the ear, the optical signal is received by the first and second light receiving portions, and the S/N ratios, for example, of the signals thus received are compared with each other. Since the first and second light receiving portions are disposed so as to be directed in different directions, one of them faces the music player or the like and the other faces away from it, for example. This causes a difference in the S/N ratios. For example, when the S/N ratio in the first light receiving portion is higher than that in the second light receiving portion, it is judged that the headphone is placed over the right ear, and the right-channel sound is outputted from the audio output portion. On the other hand, when the SIN ratio in the second light receiving portion is higher than that in the first light receiving portion, it is judged that the headphone is placed over the left ear, and the left-channel sound is outputted from the audio output portion.

This makes it possible to properly deliver the right-channel sound and the left-channel sound to the right ear and to the left ear, respectively, without the need for any user operation.

According to the invention, in the wireless headphone structured as described above, the first and second light receiving portions are disposed in such a way that the optical axes thereof are laid in a straight line forming a common optical axis, and the first and second light receiving portions are disposed so as to be symmetric with respect to a plane that is normal to the common optical axis and passes through the center of the audio output portion. With this structure, when the wireless headphone is placed over the ear, the first and second light receiving portions are arranged one in front of the other, one facing forward and the other facing backward.

Since the optical axes of the first and second light receiving portions are laid in a straight line forming a common optical axis, it is possible to make greater a difference in the S/N ratios of the signals received by the first and second light receiving portions. This makes it possible to more accurately determine over which of the ears the wireless headphone is placed. In addition, since the first and second light receiving portions are disposed so as to be symmetric with respect to a plane that is normal to the common optical axis and passes through the center of the audio output portion, the first and second light receiving portions of the wireless headphone placed over the right ear can be disposed under the same conditions as those of the wireless headphone placed over the left ear. This helps reduce the chance that the different determination results are obtained in the right and left ears.

According to the invention, in the wireless headphone structured as described above, by using a signal received by one of the first and second light receiving portions, a signal received by the other of the first and second light receiving portions is complemented. With this structure, for example, if a missing part is found in the signal received by the first light receiving portion, this missing part is recovered by using the signal received by the second light receiving portion, and the resultant signal is outputted from the audio output portion.

This makes it possible to reduce the loss of sound and thereby enhance the quality of the wireless headphone.

According to the invention, in the wireless headphone structured as described above, there is provided a position detection sensor detecting the position of the wireless headphone when the wireless headphone is placed over the ear. With this structure, if the wireless headphone is placed upside down, it is detected by the position detection sensor. Suppose that, when the wireless headphone is placed in the normal position, the right-channel sound is outputted from the audio output portion if the S/N ratio in the first light receiving portion is higher than that in the second light receiving portion. In this case, when the wireless headphone is placed upside down, the left-channel sound is outputted from the audio output portion if the S/N ratio in the first light receiving portion is higher than that in the second light receiving portion. The position detection sensor is formed with an acceleration sensor or the like.

This makes it possible to accurately determine over which of the ears the wireless headphone is placed even when the wireless headphone is placed upside down.

According to the invention, in the wireless headphone structured as described above, there are provided first and second shielding object detection sensors that detect a shielding object located in front of light receiving surfaces of the first and second light receiving portions, respectively. With this structure, an earlobe located in front of the light receiving surface of one of the first and second light receiving portions is detected by the first or second shielding object detection sensor. Based on the detection results of the first and second shielding object detection sensors, it is determined whether the wireless headphone is placed over the right ear or the left ear. The first and second shielding object detection sensors are each built with, for example, an optical triangulation range sensor or an ultrasonic sensor.

This makes it possible to more accurately determine over which of the ears the wireless headphone is placed by detecting an earlobe. In addition, the wireless headphone is automatically powered on or powered off based on the judgment whether it is placed over the ear or not. This contributes to power saving.

According to the invention, in the wireless headphone structured as described above, there are provided first and second shutters designed to be movable so as to cover the light receiving surfaces of the first and second light receiving portions, respectively. With this structure, when the user moves, for example, the first shutter so as to cover the light receiving surface of the first light receiving portion, the SIN ratio of the signal received by the second light receiving portion becomes higher than that of the signal received by the first light receiving portion. This allows the user to selectively output one of the right-channel sound and the left-channel sound.

As a result, when the user faces away from the music player or turns his/her back to the music player, for example, the user is allowed to cover one of the first and second light receiving portions. This makes it possible to accurately determine over which of the ears the wireless headphone is placed, and accordingly to further enhance the convenience of the wireless headphone.

According to the invention, a pair of wireless headphones include, as each of the pair of wireless headphones, the wireless headphone structured as described above. Here, the pair of wireless headphones each have a transmission part and a reception part, and one of the pair of wireless headphones transmits, from the transmission part thereof, signals received by the first and second light receiving portions, and receives, by the reception part thereof, a signal transmitted from the transmission part of the other of the pair of wireless headphones. By using the signal received by the reception part, the signals received by the first and second light receiving portions on the reception side are complemented.

With this structure, for example, the signals received by the first and second light receiving portions of the wireless headphone placed over the left ear are transmitted from the transmission part thereof, and are received by the reception part of the wireless headphone placed over the right ear. As a result, if a missing part is found in the signals received by the first and second light receiving portions of the wireless headphone placed over the right ear, the missing part is recovered by using the signal received by the reception part thereof, and the signal with no missing part is outputted from the audio output portion of the wireless headphone placed over the right ear.

This helps reduce the loss of sound and thereby enhance the quality of the wireless headphone.

### BRIEF DESCRIPTION OF THE DRAWINGS

FIG. 1 is a side sectional view showing a wireless headphone according to a first embodiment of the invention;

FIG. 2 is a top sectional view showing the wireless headphone according to the first embodiment of the invention;

FIG. 3 is a block diagram showing the signal processing circuit of the wireless headphone according to the first embodiment of the invention;

FIG. 4 shows, as seen from above, a state in which the wireless headphones according to the first embodiment of the invention are placed over the ears;

FIG. 5 is a top sectional view showing a wireless headphone according to a second embodiment of the invention;

FIG. 6 is a block diagram showing a signal processing circuit of a wireless headphone according to a third embodiment of the invention;

FIG. 7 is a diagram illustrating how to complement a signal by the recovery section of the wireless headphone according to the third embodiment of the invention;

FIG. 8 is a diagram illustrating how to complement a signal by the recovery section of the wireless headphone according to the third embodiment of the invention;

FIG. 9 is a diagram illustrating how to complement a signal by the recovery section of the wireless headphone according to the third embodiment of the invention;

FIG. 10 is a side sectional view showing a wireless headphone according to a fourth embodiment of the invention;

FIG. 11 shows, as seen from the side, a state in which the wireless headphone according to the fourth embodiment of the invention is placed over the ear;

FIG. 12 is a front sectional view showing a wireless headphone according to a fifth embodiment of the invention;

FIG. 13 shows, as seen from the side, a state in which the wireless headphone according to the fifth embodiment of the invention is placed over the ear;

FIG. 14 is a front sectional view showing a wireless headphone according to a sixth embodiment of the invention;

FIG. 15 is a side sectional view showing a wireless headphone according to a seventh embodiment of the invention; and

FIG. 16 is a block diagram showing the signal processing circuit of the wireless headphone according to the seventh embodiment of the invention.

### DETAILED DESCRIPTION OF PREFERRED EMBODIMENTS

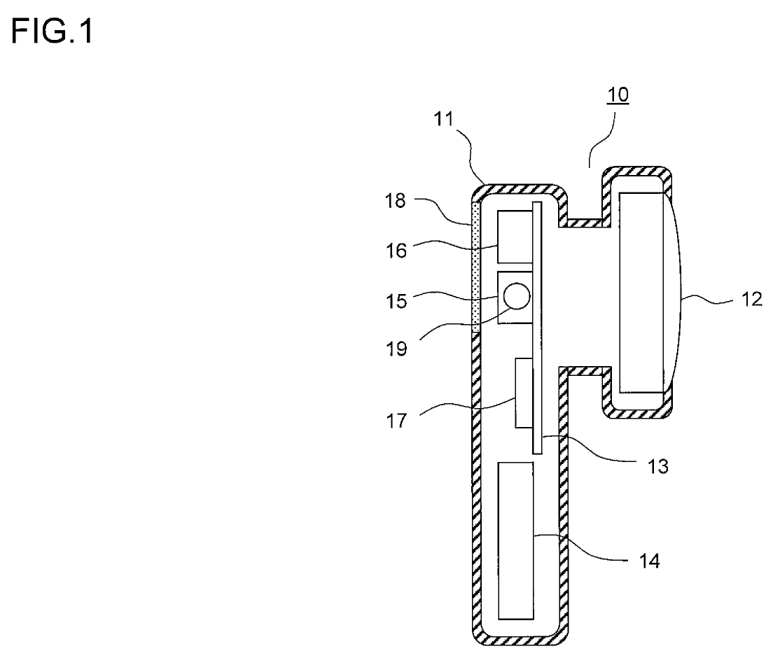

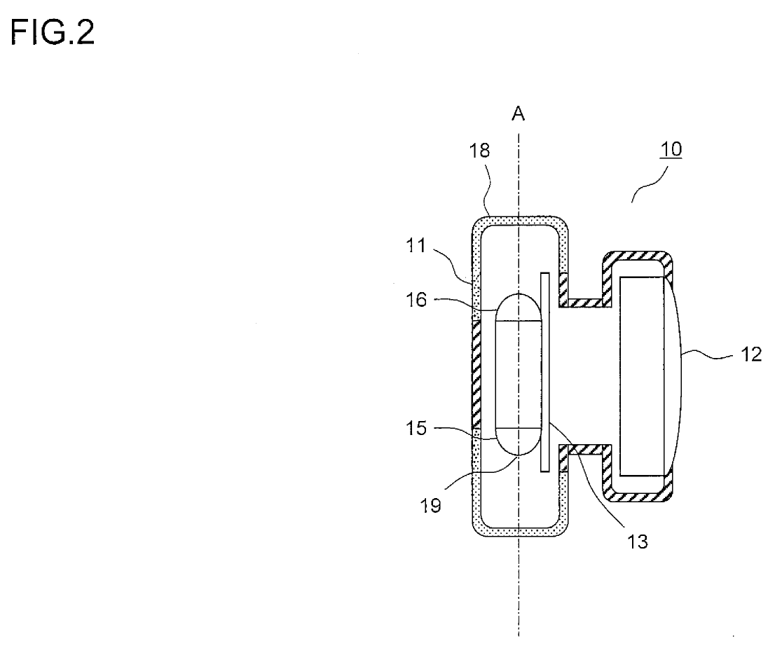

Hereinafter, embodiments of the present invention will be described with reference to the accompanying drawings. FIGS. 1 and 2 are a side sectional view and a top sectional view, respectively, showing a headphone of a first embodiment. A wireless headphone 10 is of an inner ear type, and is covered with a housing 11 except for one end thereof at which a loudspeaker (an audio output portion) 12 is provided so as to be exposed to the outside. Inside the housing 11 is provided a battery 14 and a substrate 13.

On the substrate 13, light receiving portions 15 and 16 and a signal processing circuit 17 are mounted. The light receiving portions 15 and 16 are each formed as a photoelectric conversion element that receives an audio signal in the form of an optical signal and converts the audio signal thus received into an electric signal. The light receiving portions 15 and 16 each have a condenser 19, such as a lens, at one end thereof. The optical axes A of the light receiving portions 15 and 16 including the condensers 19 are laid parallel to each other, and the light receiving portions 15 and 16 are arranged one above the another. The light receiving portions 15 and 16 have light receiving surfaces (not shown) that are disposed so as to be perpendicular to the optical axes A and are directed in the opposite directions.

The housing 11 has formed therein translucent portions 18 that allow light to pass therethrough. The translucent portions 18 are disposed on the optical axes A of the light receiving portions 15 and 16, such that the audio signal passes therethrough and is received by the light receiving portions 15 and 16. Alternatively, the translucent portions 18 may serve as the condensers 19.

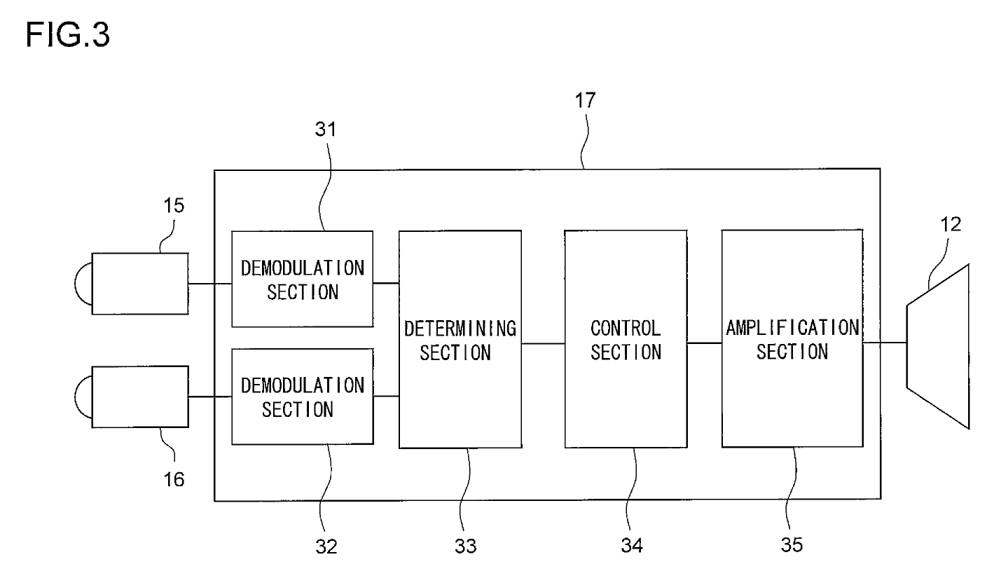

FIG. 3 is a block diagram showing the signal processing circuit 17. The signal processing circuit 17 includes demodulation sections 31 and 32, a determining section 33, a control section 34, and an amplification section 35. The demodulation sections 31 and 32 demodulate the electric signals outputted from the light receiving portions 15 and 16 back into multichannel signals. The determining section 33 compares the S/N ratios of the multichannel signals demodulated by the demodulation sections 31 and 32 to determine which one of the S/N ratios is higher than the other. Depending on the determination result of the determining section 33, the control section 34 extracts right-channel sound or left-channel sound from the multichannel signal, and then outputs it as an audio signal. The amplification section 35 amplifies the audio signal outputted from the control section 34, and outputs the amplified signal.

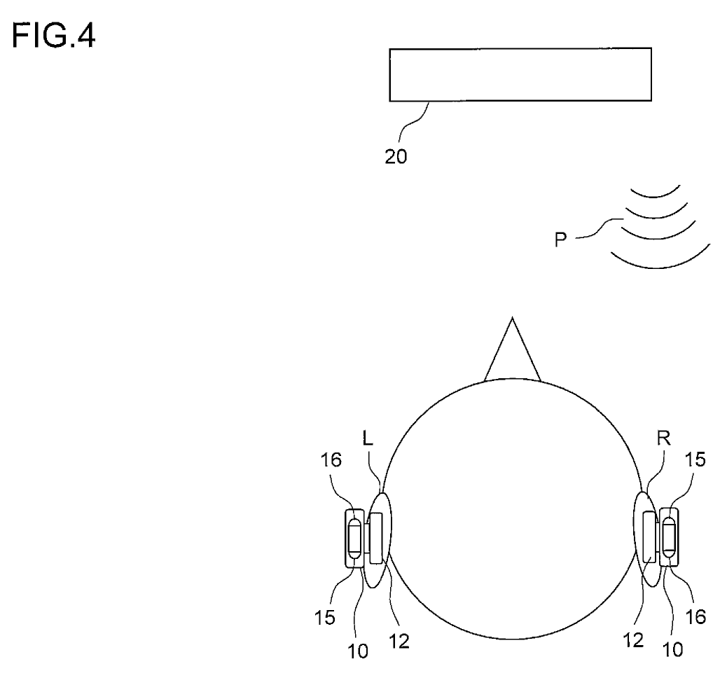

FIG. 4 is a top view showing a state in which a pair of wireless headphones 10 are placed over the ears. In the wireless headphone 10 placed over a right ear R, the light receiving surface of the light receiving portion 15 is directed forward; the light receiving surface of the light receiving portion 16 is directed backward. In the wireless headphone 10 placed over a left ear L, the light receiving surface of the light receiving portion 16 is directed forward; the light receiving surface of the light receiving portion 15 is directed backward.

A music player 20 or the like transmits, in the form of an optical signal, such as infrared radiation, an audio signal P into which a right-channel sound signal and a left-channel sound signal are multiplexed. The light receiving portions 15 and 16 individually receive the audio signal P, converts it into an electric signal, and then outputs the resultant electrical signal. At this point, as a result of the light receiving portions 15 and 16 being so disposed as to be directed in the opposite directions, the wireless headphone 10 placed over the right ear R receives a greater amount of light by the light receiving portion 15 than by the light receiving portion 16. This makes the SIN ratio of the signal received by the light receiving portion 15 higher than that of the signal received by the light receiving portion 16. When the determining section 33 determines that the SIN ratio of the signal received by the light receiving portion 15 is higher than that of the signal received by the light receiving portion 16, the control section 34 judges that the headphone 10 is placed over the right ear K, and outputs the right-channel sound.

Likewise, the wireless headphone 10 placed over the left ear L receives a greater amount of light by the light receiving portion 16 than by the light receiving portion 15. This makes the S/N ratio of the signal received by the light receiving portion 16 higher than that of the signal received by the light receiving portion 15. When the determining section 33 determines that the S/N ratio of the signal received by the light receiving portion 16 is higher than that of the signal received by the light receiving portion 15, the control section 34 judges that the headphone 10 is placed over the left ear L, and outputs the left-channel sound.

According to this embodiment, there are provided the light receiving portions 15 and 16 disposed so as to be directed in the opposite directions, and an output from the loudspeaker 12 is switched between the right-channel sound and the left-channel sound based on the result of the comparison of the S/N ratios of the signals received by the light receiving portions 15 and 16. This makes it possible to properly deliver the right-channel sound and the left-channel sound to the right ear and to the left ear, respectively, without the need for any user operation.

Although the descriptions heretofore deal with a case where the light receiving portions 15 and 16 are disposed 180 degrees opposite to each other, they may be disposed in any other way than is specifically described above as long as, when the headphone is placed over the ear, the light receiving portions 15 and 16 are directed in different directions, such that the light receiving surface of one of the light receiving portions 15 and 16 is directed forward and the light receiving surface of the other is directed backward.

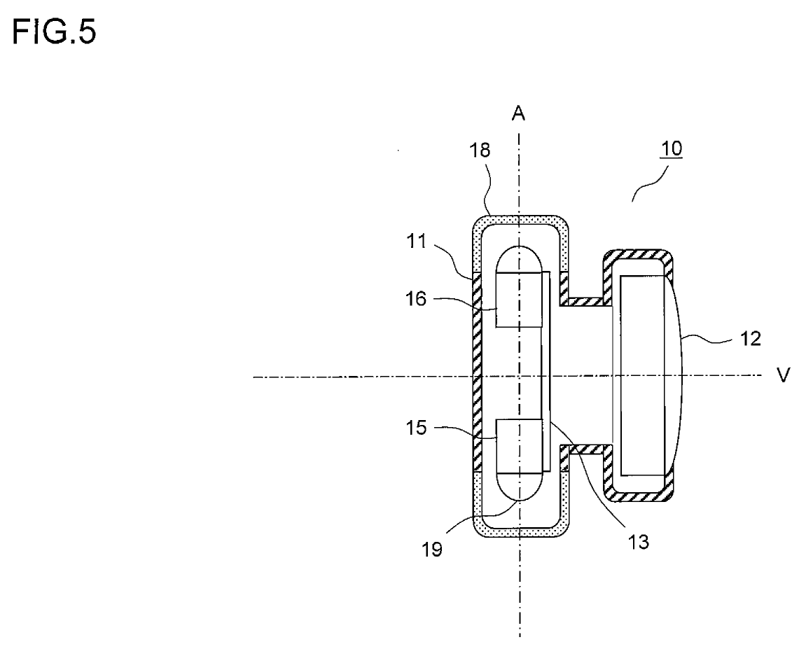

Next, FIG. 5 is a top sectional view showing a wireless headphone according to a second embodiment. For the sake of convenience, such components as find their counterparts in the first embodiment shown in FIGS. 1 to 4 described above are identified with the same reference numerals. This embodiment differs from the first embodiment only in the arrangement of the light receiving portions 15 and 16. In other respects, this embodiment is the same as the first embodiment.

The light receiving portions 15 and 16 are disposed in such a way that the optical axes thereof are laid in a straight line forming a common optical axis A, and are disposed so as to be symmetric with respect to a plane V that is normal to the common optical axis A and passes through the center of the loudspeaker 12. Since the optical axes of the light receiving portions 15 and 16 are laid in a straight line forming a common optical axis A, the light receiving portions 15 and 16 are directed in the opposite directions, making it possible to increase the difference between the SIN ratios of the signals received thereby. This makes it possible to accurately determine over which of the ears the wireless headphone 10 is placed.

In addition, the light receiving portion 15 for the left ear L and the light receiving portion 16 for the right ear R are at the same position with respect to the position of the ear, and the light receiving portion 16 for the left ear L and the light receiving portion 15 for the right ear R are at the same position with respect to the position of the ear. This allows the right and left ears to receive the audio signal P the same way, making it possible to determine over which of the ears the wireless headphone 10 is placed under the approximately the same reception conditions. This helps reduce the chance that different determination results are obtained on the right and left sides. Furthermore, this makes it possible to reduce the dimension of the wireless headphone 10 in the vertical direction.

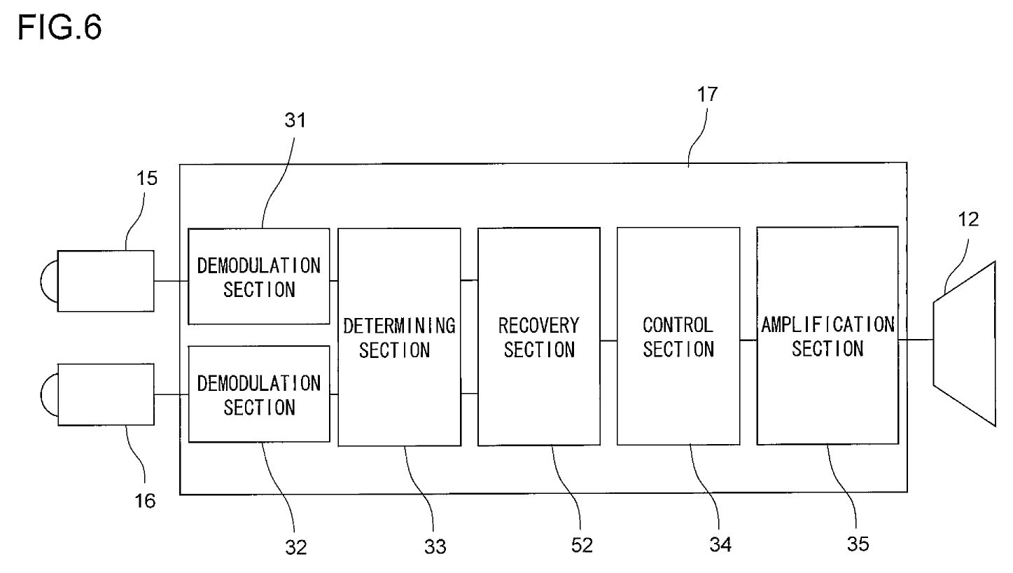

Next, FIG. 6 is a block diagram showing the structure of the signal processing circuit of a wireless headphone according to a third embodiment. For the sake of convenience, such components as find their counterparts in the first embodiment shown in FIG. 3 described above are identified with the same reference numerals. This embodiment differs from the first embodiment only in the structure of the signal processing circuit 17. In other respects, this embodiment is the same as the first embodiment.

The signal processing circuit 17 of this embodiment has a recovery section 52 between the determining section 33 and the control section 34. The recovery section 52 compares the signal received by the light receiving portion 15 with the signal received by the light receiving portion 16, recovers lost information of the signal, and then output the resultant signal.

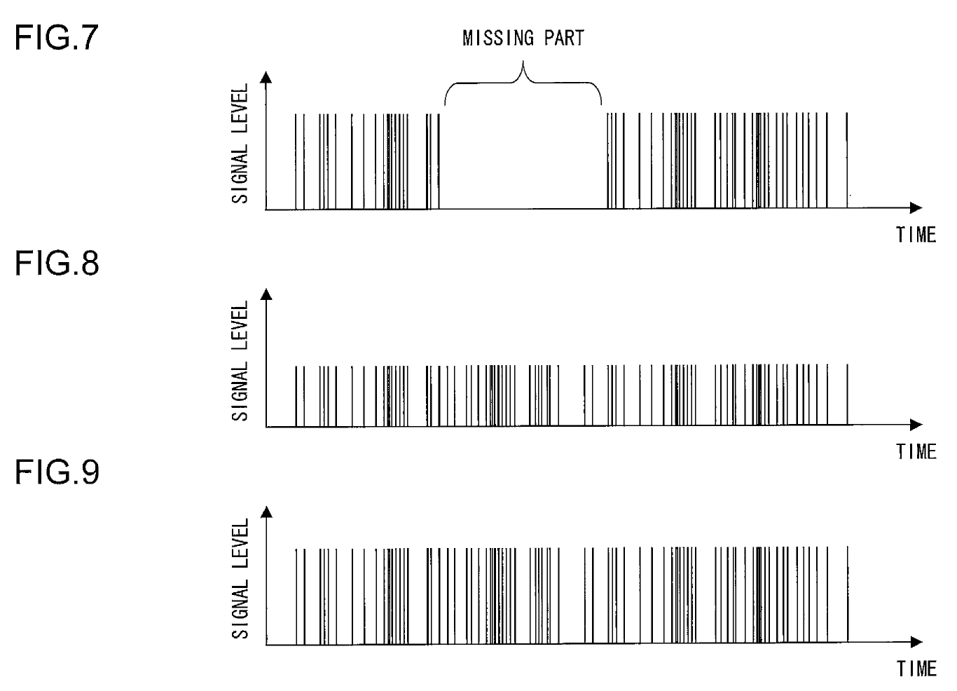

FIGS. 7 to 9 are each a diagram illustrating how to complement a signal by the recovery section 52. FIG. 7 shows an example of an output signal of the light receiving portion 15, and FIG. 8 shows an example of an output signal of the light receiving portion 16. FIG. 9 shows an example of an output signal of the recovery section 52. In these drawings, the vertical axis represents the signal level, and the horizontal axis represents time. The signals received by the light receiving portions 15 and 16 are subjected to photoelectric conversion, and then outputted. The S/N ratios of the signals thus outputted are compared with each other by the determining section 33. In this example, the signal level and hence the S/N ratio in the light receiving portion 15 are higher than those in the light receiving portion 16. Therefore, it is judged that the headphone 10 is placed over the right ear R.

Next, the recovery section 52 compares signal levels of the signals received by the light receiving portions 15 and 16 to determine whether or not there is a missing part in the output signal of the light receiving portion 15. In this example, the comparison between the signal shown in FIG. 7 and the signal shown in FIG. 8 reveals that there is a missing part in the output signal of the light receiving portion 15. This missing part in the output signal of the light receiving portion 15 is recovered by using the output signal of the light receiving portion 16. At this point, the missing part is recovered by amplifying the signal level of the output signal of the light receiving portion 16 to the level of the output signal of the light receiving portion 15. As a result, as shown in FIG. 9, the signal with no missing part is outputted from the recovery section 52. Incidentally, when no missing part is found in the output signal of the light receiving portion 15, the signal is outputted from the recovery section 52 as it is.

According to this embodiment, the signal received by one of the light receiving portions 15 and 16 is complemented by using the signal received by the other. This makes it possible to reduce the loss of sound and thereby enhance the quality of the wireless headphone 10. Incidentally, the signal processing circuit 17 of the wireless headphone 10 according to the second embodiment may be structured in the same manner as that described in this embodiment.

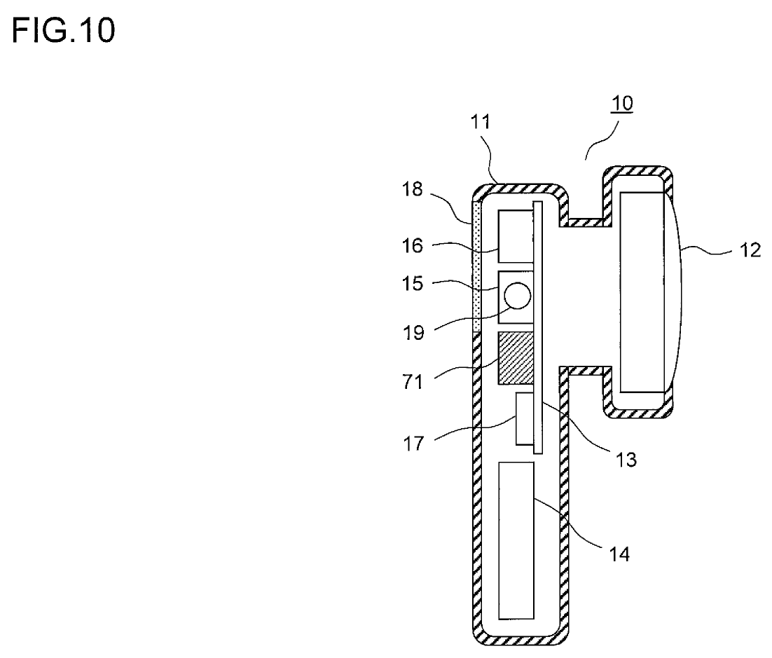

Next, FIG. 10 is a side sectional view showing a wireless headphone according to a fourth embodiment. For the sake of convenience, such components as find their counterparts in the first embodiment shown in FIGS. 1 to 4 described above are identified with the same reference numerals. This embodiment differs from the first embodiment only in that there is further provided, in addition to the components of the first embodiment, a position detection sensor 71 for detecting the position of the wireless headphone 10 when it is placed over the ear. In other respects, this embodiment is the same as the first embodiment.

For example, the position detection sensor 71 may include a light receiving element, a light emitting element, and a spherical object, so that the reception of light is blocked by the spherical object if it is moved to a certain location. Alternatively, the position detection sensor 71 may be formed with an acceleration sensor. Based on the S/N ratios of the signals received by the light receiving portions 15 and 16 and the detection result of the position detection sensor 71, the determining section 33 (see FIG. 3) determines over which of the ears the wireless headphone 10 is placed.

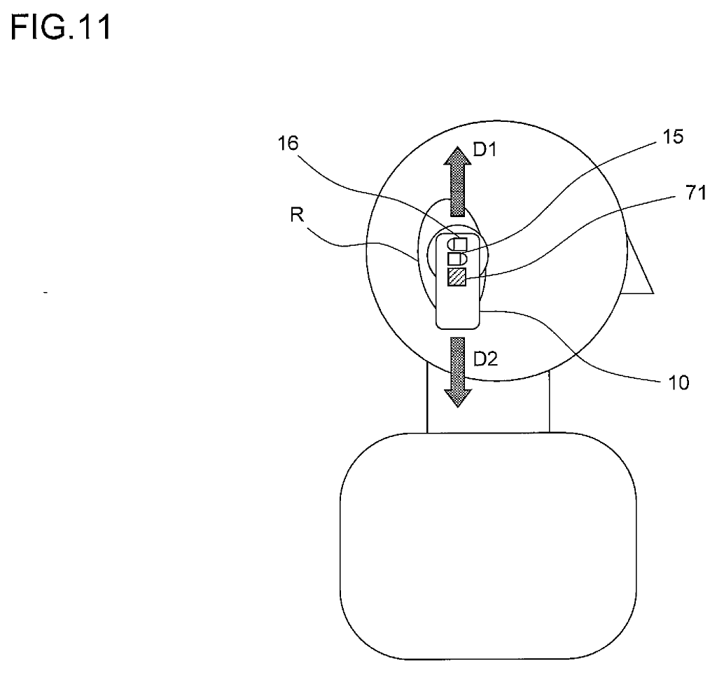

FIG. 11 shows, as seen from the side, a state in which the wireless headphone 10 is placed over the right ear R. Let the direction toward the light receiving portion 16 from the position detection sensor 71 be D1, and the direction toward the position detection sensor 71 from the light receiving portion 16 be D2. Then, suppose that the S/N ratio of the signal received by the light receiving portion 15 is higher than that of the signal received by the light receiving portion 16. In this case, if the direction D2 is a downward direction, the determining section 33 determines that the headphone 10 is placed over the right ear R. On the other hand, if the direction D1 is a downward direction, the determining section 33 determines that the headphone 10 is placed over the left ear L.

Suppose that the S/N ratio of the signal received by the light receiving portion 16 is higher than that of the signal received by the light receiving portion 15. In this case, if the direction D2 is a downward direction, the determining section 33 determines that the headphone 10 is placed over the left ear L. On the other hand, if the direction D1 is a downward direction, the determining section 33 determines that the headphone 10 is placed over the right ear R.

As described above, it is possible to accurately determine over which of the ears the wireless headphone 10 is placed even when the wireless headphone 10 is placed upside down. Incidentally, the wireless headphones 10 of the second and third embodiments may be provided with the position detection sensor 71.

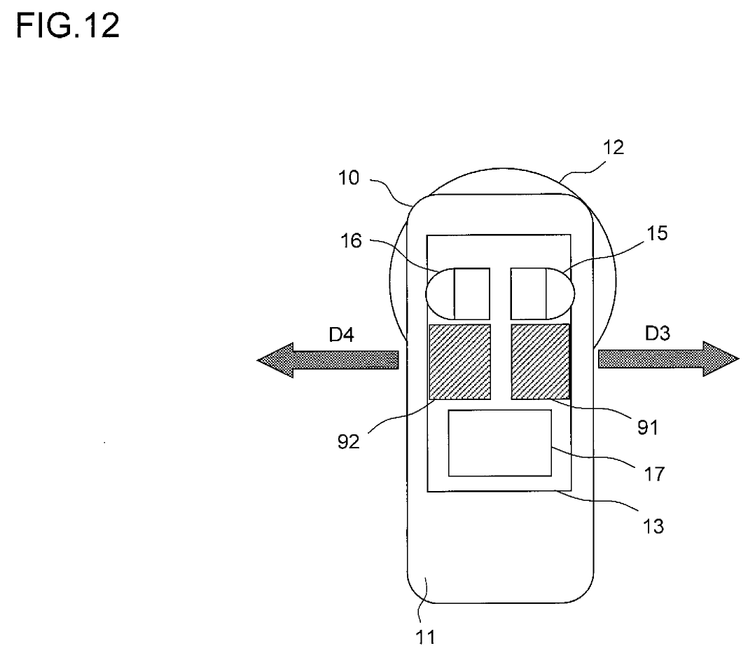

Next, FIG. 12 is a front sectional view showing a wireless headphone according to a fifth embodiment. For the sake of convenience, such components as find their counterparts in the second embodiment shown in FIG. 5 described above are identified with the same reference numerals. This embodiment differs from the second embodiment only in that there are further provided, in addition to the components of the second embodiment, shielding object detection sensors 91 and 92 that detect a shielding object located in front of the light receiving surfaces of the light receiving portions 15 and 16, respectively. In other respects, this embodiment is the same as the second embodiment.

The shielding object detection sensors 91 and 92 are each built with, for example, an optical triangulation range sensor or an ultrasonic sensor. This enables them to detect the presence of a shielding object located a few millimeters to several tens of centimeters in front of the light receiving surface (in a D3 or D4 direction) by sensing light emanating from or sound reflected from the shielding object. The determining section 33 (see FIG. 3) determines over which of the ears the wireless headphone 10 is placed based on the SIN ratios of the signals received by the light receiving portions 15 and 16 and the detection results of the shielding object detection sensors 91 and 92.

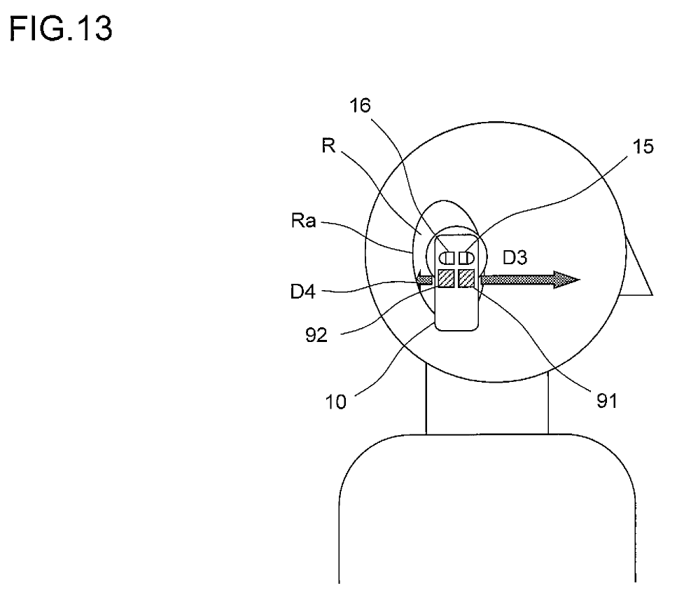

FIG. 13 shows, as seen from the side, a state in which the wireless headphone 10 is placed over the right ear R. When the wireless headphone 10 is placed over the right ear R, an earlobe Ra of the right ear R is detected by the shielding object detection sensor 92 as a shielding object in the D4 direction. At this point, no shielding object in the D3 direction is detected by the shielding object detection sensor 91. Likewise, when the wireless headphone 10 is placed over the left ear L, an earlobe of the left ear L is detected by the shielding object detection sensor 91 as a shielding object in the D3 direction. At this point, no shielding object in the D4 direction is detected by the shielding object detection sensor 92.

The determining section 33 determines over which of the ears the wireless headphone 10 is placed based on which one of the S/N ratios of the signals received by the light receiving portions 15 and 16 is higher than the other. However, in a case where, for example, the user faces in the direction at right angles to the direction of the optical signal transmitted from the music player 20 (see FIG. 4) or the like, the difference between the S/N ratios of the signals received by the light receiving portions 15 and 16 becomes lower than a predetermined value. This may make it difficult to determine which one of the S/N ratios is higher than the other. Sometimes one of the S/N ratios becomes higher than the other, and vice versa, at more frequent intervals than are specified within a predetermined period of time.

In such cases, based on the detection results of the shielding object detection sensors 91 and 92, the ear over which the wireless headphone 10 is placed is determined. That is, if a shielding object is detected by the shielding object detection sensor 92, it is judged that the wireless headphone 1 0 is placed over the right ear R. On the other hand, if a shielding object is detected by the shielding object detection sensor 91, it is judged that the wireless headphone 10 is placed over the left ear L.

According to this embodiment, there are provided the shielding object detection sensors 91 and 92 that detect a shielding object located in front of the light receiving surfaces of the light receiving portions 15 and 16, respectively. As a result, even when, for example, the user faces in the direction at right angles to the direction of the optical signal transmitted from the music player 20 or the like, it is possible to accurately determine over which of the ears the wireless headphone 10 is placed by sensing an earlobe. In addition, the wireless headphone 10 is automatically powered on or powered off based on the judgment whether it is placed over the ear or not. This contributes to power saving. Incidentally, the wireless headphones 10 of the first, third, and fourth embodiments may be provided with the shielding object detection sensors 91 and 92.

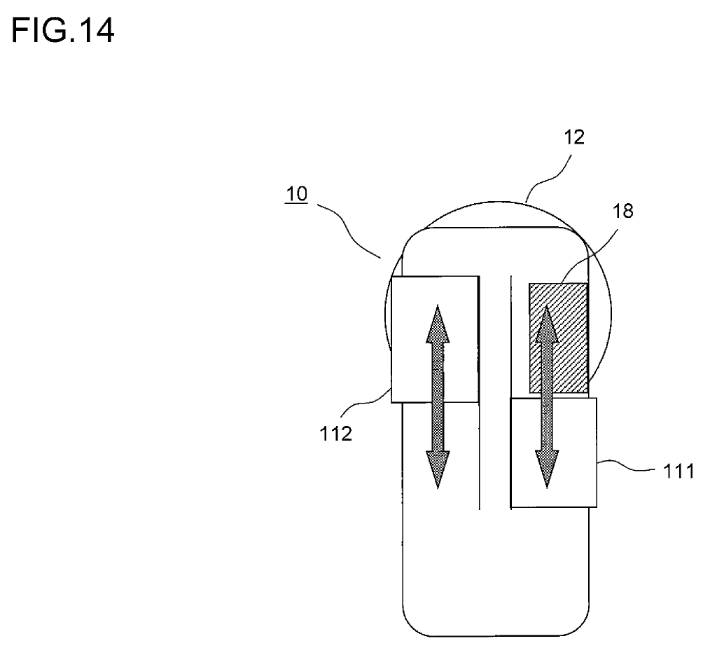

Next, FIG. 14 is a front view showing a wireless headphone according to a sixth embodiment. For the sake of convenience, such components as find their counterparts in the first embodiment shown in FIGS. I to 4 described above are identified with the same reference numerals. This embodiment differs from the first embodiment only in that there are further provided, in addition to the components of the first embodiment, movable shutters 111 and 112 that cover the translucent portions 18 facing the light receiving portions 15 and 16, respectively. In other respects, this embodiment is the same as the first embodiment.

The shutters 111 and 112 are each formed of a lightproof material. The shutters 111 and 112 are individually moved up and down according to the user operation so as to cover and uncover the translucent portions 18. This allows the user to cover the light receiving surfaces of the light receiving portions 15 and 16, thereby preventing an audio signal in the form of an optical signal from reaching the light receiving surfaces.

According to this embodiment, even when the difference between the SIN ratios of the signals received by the light receiving portions 15 and 16 becomes lower than a predetermined value because the user faces in the direction at right angles to the direction of the optical signal transmitted from the music player 20 (see FIG. 4) or the like, or even when one of the S/N ratios becomes higher than the other, and vice versa, at frequent intervals, it is possible to accurately determine which one of the S/N ratios is higher than the other by closing the shutter located in a rearward direction with respect to the user. Alternatively, even when the user turns his/her back to the music player 20 or the like, it is possible to prevent, by closing the shutters located in a rearward direction with respect to the user, the headphones 10 placed over the right and left ears from being erroneously judged to be placed over the left and right ears, respectively. Incidentally, the wireless headphones 10 of the second to fifth embodiments may be provided with the shutters 111 and 112.

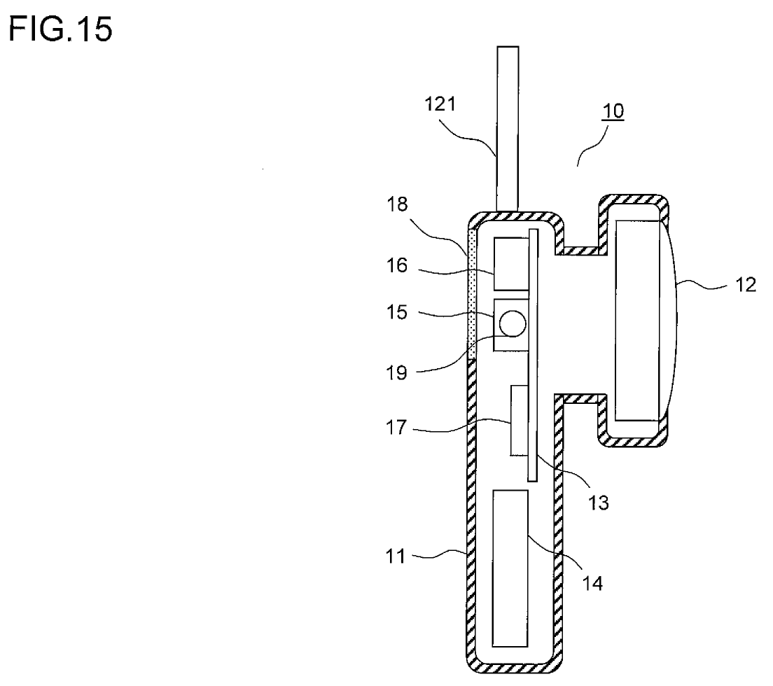

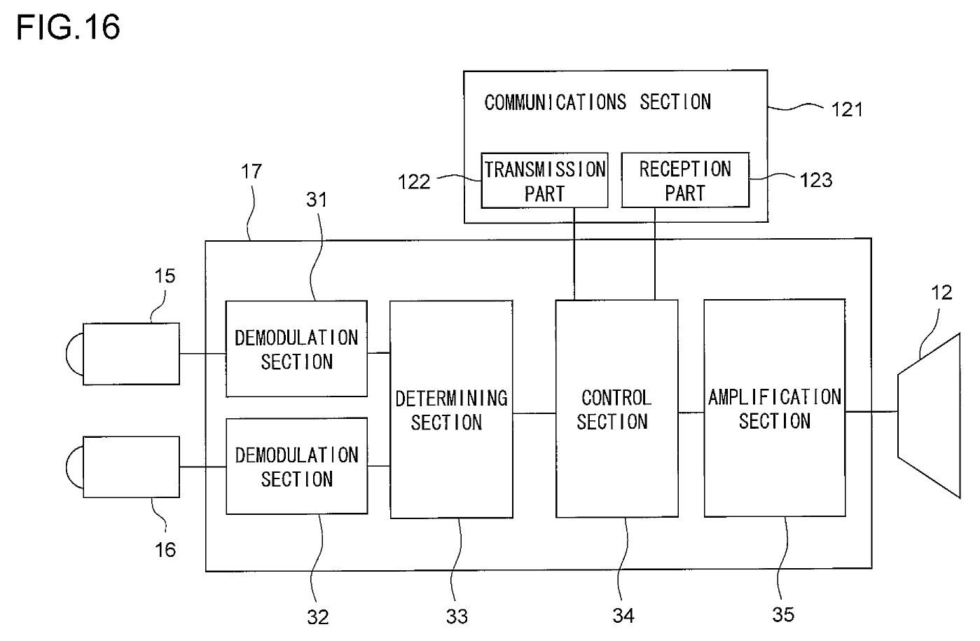

Next, FIG. 15 is a side sectional view showing a wireless headphone according to a seventh embodiment, and FIG. 16 is a block diagram showing the signal processing circuit of the wireless headphone. For the sake of convenience, such components as find their counterparts in the first embodiment shown in FIGS. 1 to 4 described above are identified with the same reference numerals. This embodiment differs from the first embodiment only in that there is further provided, in addition to the components of the first embodiment, a communications section 121 In other respects, this embodiment is the same as the first embodiment.

As shown in FIG. 4 described above, a pair of wireless headphones 10 is provided. The communications section 121 includes a transmission part 122 and a reception part 123. The control section 34 of one of the pair of wireless headphones 10 sends one of the signals received by the light receiving portions 15 and 16, the one having a higher signal level than the other, to the transmission part 122, and makes the transmission part 122 transmit the signal. The reception part 123 receives a signal transmitted from the transmission part 121 of the other of the pair of wireless headphones 10. Although this embodiment deals with a case where the communications section 121 adopts wireless transmission and reception, it is also possible to adopt wired transmission and reception.

The control section 34 compares signal levels between the signals received by the light receiving portions 15 and 16 and the signal received by the reception part 123 to determine whether or not there is a missing part in the signals received by the light receiving portions 15 and 16. In a similar manner as described with FIGS. 7 to 9, if a missing part is found in the signals received by the light receiving portions 15 and 16, this missing part is recovered by using the signal received by the reception part 123. As a result, the signal with no missing part is outputted from the control section 34. Incidentally, when no missing part is found in the signals received by the light receiving portions 15 and 16, the signal is outputted from the control section 34 as it is.

According to this embodiment, one of a pair of wireless headphones 10 placed over the ears transmits the signals received by the light receiving portions 15 and 16 from the transmission part 122, and receives, at the reception part 123, a signal transmitted from the transmission part 122 of the other of the pair of wireless headphones 10. By using the signal thus received, the signals received by the light receiving portions 15 and 16 are complemented. This helps reduce the loss of sound and thereby enhance the quality of the wireless headphone 10. Incidentally, the wireless headphones 10 of the second to sixth embodiments may be provided with the communications section 121.

The first to seventh embodiments deal with cases where the determining section 33 compares the S/N ratios of the signals received by the light receiving portions 15 and 16 to determine over which of the ears the wireless headphone 10 is placed. Instead, signal levels of the signals received by the light receiving portions 15 and 16 may be compared to determine over which of the cars the wireless headphone 10 is placed.

The present invention can be applied to wireless headphones that receive an audio signal in the form of an optical signal and output sound.

What is claimed is:

1. A wireless headphone that receives an audio signal including a right-channel sound signal and a left-channel sound signal and outputs sound from an audio output portion,
wherein the audio signal is in a form of an optical signal,
wherein the wireless headphone comprises first and second light receiving portions disposed so as to be directed in different directions, the first and second light receiving portions receiving the audio signal,
wherein S/N ratios or signal levels of the signals received by the first and second light receiving portions are compared so that, based on a comparison result, an output from the audio output portion is switched between right-channel sound and left-channel sound.

2. The wireless headphone of claim 1,
wherein the first and second light receiving portions are disposed in such a way that optical axes thereof are laid in a straight line forming a common optical axis,
wherein the first and second light receiving portions are disposed so as to be symmetric with respect to a plane that is normal to the common optical axis and passes through a center of the audio output portion.

3. The wireless headphone of claim 1,
wherein, by using a signal received by one of the first and second light receiving portions, a signal received by the other of the first and second light receiving portions is complemented.

4. The wireless headphone of claim 1, further comprising:
a position detection sensor detecting a position of the wireless headphone when the wireless headphone is placed over an ear.

5. The wireless headphone of claim 1, further comprising:
first and second shielding object detection sensors that detect a shielding object located in front of light receiving surfaces of the first and second light receiving portions, respectively.

6. The wireless headphone of claim 1, further comprising:
first and second shutters designed to be movable so as to cover light receiving surfaces of the first and second light receiving portions, respectively.

7. A pair of wireless headphones, comprising:
as each of the pair of wireless headphones, the wireless headphone of claim 1,
wherein the pair of wireless headphones each have a transmission part and a reception part,
wherein one of the pair of wireless headphones transmits, from the transmission part thereof, signals received by the first and second light receiving portions, and receives, by the reception part thereof, a signal transmitted from the transmission part of the other of the pair of wireless headphones,
wherein, by using the signal received by the reception part, the signals received by the first and second light receiving portions on a reception side are complemented.
